(19) United States
(12) Patent Application Publication
(10) Pub. No.: US 2005/0270321 A1
(43) Pub. Date: Dec. 8, 2005

(54) Program product, device, and method for color chart discrimination and program product, device, and method for color correction

(75) Inventor: Satoru Ono, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/127,305

(22) Filed: May 12, 2005

(30) Foreign Application Priority Data
May 13, 2004 (JP) 2004-143556

(51) Int. Cl. B41J 29/38

(52) U.S. Cl. 347/14

(57) ABSTRACT

Conventionally, wasteful processes are required for identifying the printing conditions for a color chart. According to the present invention, the printing conditions are identified as follows: a printing condition acquisition unit acquires predetermined printing conditions under which a color chart is outputted from a printing device. A color chart output unit outputs a color chart in which the disposition of predetermined patches is specified in correspondence with the acquired printing conditions under the printing conditions. A printing condition identification unit acquires the disposed positions of the predetermined patches when the color chart is subjected to color measurement to acquire the color value of each patch, and identifies the printing conditions based on the disposed positions.

### BACKGROUND OF THE INVENTION

1. Field of the Invention

The present invention relates to a program product, a device, and a method for color chart discrimination and a program product, a device, and a method for color correction.

2. Description of the Related Art

To perform calibration to correct color shifts in a print result of a printing device, for example, the following procedure is conventionally taken: the printing device is caused to output a color chart in which a plurality of patches are printed based on predetermined image data. The color of each patch on the color chart is measured with a color measurement device or the like. The thus obtained color value of each patch is compared with a predetermined reference value. Based on the result of comparison, LUTs (Look-Up Tables) for converting the colors of color image data are corrected.

Some publicly known documents describe image formation systems so designed that the following operation is performed: a test pattern is outputted and identification information about an image output device that outputted the test pattern is outputted at the same time. The image output device to be calibrated is identified based on input information associated with the identification information. (Refer to Japanese Unexamined Patent Publication No. 2001-180090 (hereafter, referred to as “Patent Document 1”), for example.)

To calibrate a plurality of printing devices, a color chart is printed with each of the printing devices. At this time, conventionally, various problems arise. It is impossible to know with which printing device each color chart was printed. It is further difficult to exactly grasp the correspondence between color charts and printing conditions to be calibrated especially in the following cases: when some time has passed before color measurement is carried out after a plurality of color charts are printed; and when a plurality of color charts are printed with one printing device with the setting of print resolution, paper, or the like varied.

In the technology described in Patent Document 1, the identification code for a printer, in addition to test pattern, is printed. Therefore, the marking is printed, which is otherwise unnecessary to acquire color measurement values required for calibration.

This is also the case with scanning of a test pattern document. The identification code must be scanned. This is superfluous scanning operation that is different from the acquisition of color measurement values required for calibration.

In addition, the following problem arises when an identification code is printed separately from a test pattern, as described in the above patent document: equipment provided with a function of scanning the identification code as well as a color measuring function must be used. This limits equipment used for color measurement.

### SUMMARY OF THE INVENTION

The present invention has been made with the above problems taken into account. It is therefore an object of the present invention is to provide a program product, a device, and a method for color chart discrimination and a program product, a device, and a method for color correction wherein a plurality of color charts printed under various conditions can be correctly identified without performing wasteful printing or image scanning operation.

To attain the above object, a color chart discrimination program product according to the invention causes a computer to execute the following program codes and carry out corresponding functions. A printing condition acquisition program code is for acquiring printing conditions when a color chart is outputted with a printing device. A color chart output program code is for printing the color chart under the acquired printing conditions. The color chart printed at this time is so constructed that the disposition of a predetermined patch is determined in correspondence with the acquired printing conditions.

A printing condition identification program code is for acquiring the position in which the predetermined patch is disposed when the colors of the color chart are measured to acquire the color value of each patch. Then, the printing condition identification program code identifies the printing conditions based on the disposed position.

More specific description will be given. In an ordinarily printed color chart constituted of patches, the disposed position of a predetermined patch is uniquely determined based on differences in printing conditions. As a result, under what conditions the color chart was printed can be determined just by measuring the colors of the color chart. It is unnecessary to print any marking other than patches in respective ink colors constituting an ordinary color chart, and it is also unnecessary to scan any marking other than patches. Therefore, printing of the color chart and measurement of its colors can be carried out with efficiency.

The following constitution may be adopted as another constitution of the invention: in the printing condition acquisition program code, acquired printing conditions include at least information for identifying the printing device that outputs a color chart. With this constitution, printed color charts are different in the disposed position of a predetermined patch from printing device to printing device that outputs the color chart. As a result, the following advantage is brought: even when the colors of color charts printed with a plurality of printing devices are measured, with which printing device each color chart was printed can be determined with reliability by measuring the colors of the color chart.

In addition to identification information about each printing device, various settings can be used for the acquired printing conditions. Possible settings include print resolution, the type of media used, and the like. By varying the disposition of a patch in conjunction with a difference in printing conditions, the environment in which each color chart was printed can be identified with higher precision.

The following constitution may be adopted as another constitution of the invention: the color chart output program code refers to the correspondence between each set of printing conditions and patch disposition information that defines the disposed position of the predetermined patch on color charts, stored in a predetermined storage area in advance. The color chart output program code thereby acquires patch disposition information corresponding to the acquired printing conditions. Then, it outputs the color chart for which the disposed position of the predetermined patch is determined based on the acquired patch disposition information.

As mentioned above, the correspondence between each set of printing conditions and patch disposition information that uniquely corresponds thereto is referred to. Thus, color charts different in the disposition of a predetermined patch from a set of printing conditions to another can be printed with ease.

The following constitution may be adopted as another constitution of the invention: the printing condition identification program code acquires specific patch disposition information based on the result of color measurement on the above color chart. Further, it refers to the above correspondence to identify the printing conditions. The patch disposition information of each of the individual color charts can be acquired based on the color value of each patch. Therefore, the printing conditions for each color chart can be identified with reliability by referring to the correspondence, referred to when a color chart is printed, also during color measurement.

Up to this point, description has been given to constitutions for identifying the printing conditions for color charts. When these constitutions are used upon correction of any color shift in a printing device, their usefulness is enhanced.

Even when printing operation is performed base on the same input image data, the degree of color shift in print results differ in the following cases: cases where printing devices are different, and cases where the same printing device is used but various settings of print resolution or the like are different. For this reason, correction of the color shifts can be carried out with respect to each set of printing conditions, including difference in printing device and difference in various settings. When a color chart is printed under certain printing conditions in an attempt to correct color shift under the printing conditions, the following procedure must be used: the color values acquired from the color chart are used without fail to correct color shift under the printing conditions to be corrected.

According to the invention, consequently, a color correction program product that corrects color shift in a printing device using the above color chart discrimination program product causes a computer to execute the following processes: when the above printing conditions are identified based on the color measurement on color patches, a color correction program code implements the following: based on the color value of each patch, acquired from the color measurement, correspondence for color conversion to be applied during printing operation under the identified printing conditions is corrected. For this reason, the following color value is prevented from being used when some correspondence for color conversion is corrected: a color value acquired from a color chart printed under printing conditions different from printing conditions on which the application of the correspondence for color conversion is based.

The following constitution may be adopted as another constitution of the color correction program product: the color correction program code compares the printing conditions identified based on the color measurement with printing conditions for confirmation separately acquired as printing conditions under which the color chart was outputted. If there is any difference between the conditions, the computer is caused to perform a predetermined warning process. The above printing conditions for confirmation refer to printing conditions a user acquired by making input as printing conditions under which the color chart was outputted, during color measurement.

When the warning process is performed, the following advantage is brought: if a user actually measures the colors of a color chart printed under printing conditions different from the printing conditions the color shift under which the user intends to correct, the user can recognize the mistake. When the user recognizes the mistake, the user can choose to do the following: the user can correct color shift under printing conditions different from the ones for the correction of the color shift intended by the user, based on the color values acquired from the color measurement; or the user can measure anew the colors of a color chart printed under the printing conditions for the correction of the color shift intended by the user.

Up to this point, techniques for discriminating color charts and techniques for color correction utilizing the discrimination have been described as an invention of program product. The underlying technical idea can be implemented as an invention of device for embodying the technical idea. In this case, the same action as mentioned above is produced.

The technical idea behind the present invention allows the invention to be interpreted as a procedure for embodying the technical idea.

### BRIEF DESCRIPTION OF THE DRAWINGS

FIG. 1 is a schematic block diagram of a calibration system in an embodiment.

FIG. 2 is a schematic block diagram of a color correction device in the embodiment.

FIG. 3 is a flowchart illustrating the details of printing operation for a color chart.

FIG. 4 is an explanatory drawing illustrating the details of a DB.

FIG. 5 is an explanatory drawing illustrating a color chart.

FIG. 6 is a flowchart illustrating the details of process steps from color measurement to calibration.

FIG. 7 is a flowchart illustrating calibration in detail.

FIG. 8 is a projection drawing of color values on the a*b* plane.

FIG. 9 is a flowchart illustrating the process steps from color measurement to calibration in another embodiment.

### DESCRIPTION OF THE PREFERRED EMBODIMENTS

Description will be given to embodiments of the invention in the following order:

(1) General Constitution of Embodiment

(2) Printing Operation for Color Chart

(3) Calibration

(4) Other Embodiments

(5) Conclusion

### (1) General Constitution of Embodiment

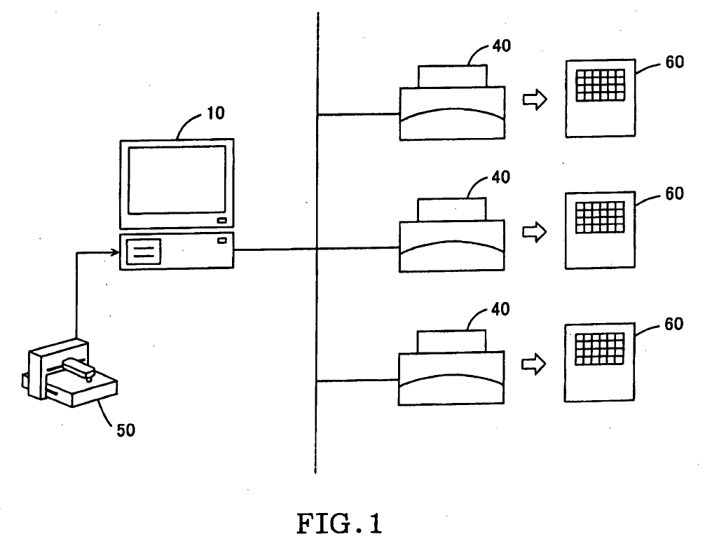

FIG. 1 schematically illustrates a calibration system utilizing the present invention.

In the example in this figure, a computer 10 is connected with a plurality of printers 40. In this embodiment, a plurality of the printers 40 are to be calibrated, and the printers 40 are caused to print a color chart 60 for calibration. The colors of the printed color charts 60 are measured with a color measurement device 50, and the thus obtained color value are taken into the computer 10. Thus, the predetermined calibration is carried out on each of the printers 40.

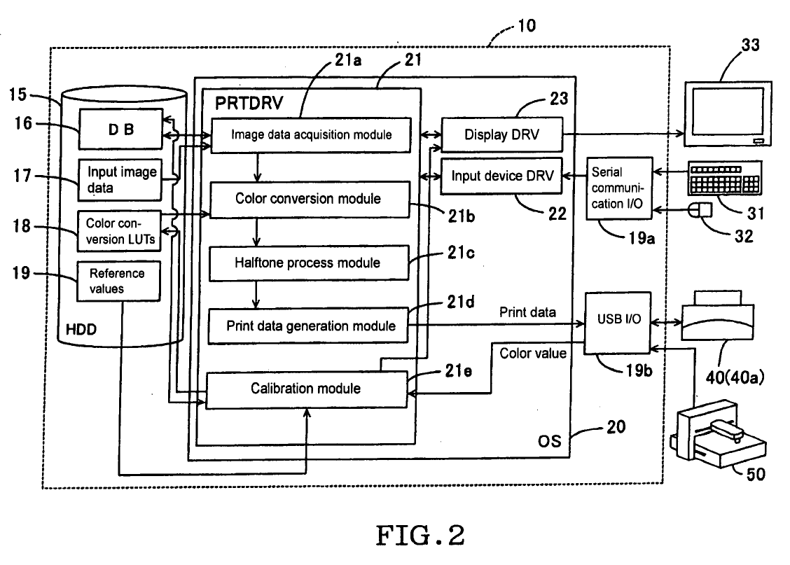

FIG. 2 conceptually illustrates hardware configuration and software configuration associated with this embodiment. Needless to add, each piece of software is implemented by program code, and these pieces of software as a whole constitute a program product.

The computer 10 is provided with a CPU (not shown) that serves the nerve center of computation, a ROM and a RAM as storage medium, and the like. The computer executes predetermined programs utilizing peripheral equipment, such as a HDD 15. The computer 10 is connected with input devices for operation, such as a keyboard 31 and a mouse 32, through a serial communication I/O 19a. It is also connected with a display 3 for indication through a video board (not shown). In addition, the computer is connected with a printer 40a through a USB I/O 19b. In this figure of printers 40 connected with the computer 10, only the printer 40a is shown for simplicity.

The printer 40a is provided with a mechanism that allows ink cartridges filled with a plurality of color inks to be mounted and dismounted on a color-by-color basis. The mechanism is mounted with cartridges of inks in C, M, Y, and K (Cyan, Magenta, Yellow, and black). The printer 40a can form a large number of colors by combining these ink colors, and thus forms color images on printing media. The printer 40a in this embodiment is an ink jet printer; however, the present invention is applicable to various other types of printers, including laser printers.

The constitution in which four colored inks, or C, M, Y, and K inks, are used is not indispensable. Various other constitutions, for example, those in which six colors of C, M, Y, K, Lc (Light cyan), and Lm (Light magenta), or seven colors of C, M, Y, K, Lc, Lm, and DY (Dark Yellow), may be adopted.

The computer 10 is fed with predetermined color values from the color measurement device 50 through the USB I/O 19b. The color measurement device 50 is so constituted that the following can be implemented: printed matter is irradiated with light from a light source whose spectral reflectance is known. The reflected light from the printed matter is detected, and thereby the spectral reflectance of the printed matter is detected. Then, its color values, for example, L*a*b* values and XYZ values, are outputted. In this embodiment, the L*a*b* value of each patch in the color chart 60 printed with each printer 40 is acquired.

In the computer 10, a printer driver (PRTDRV) 21, an input device driver (DRV) 22, and a display driver (DRV) 23 are installed in its OS 20. The display DRV 23 is a driver that controls the displays of images to be printed, a printer property screen, and the like on the display 33. The input device DRV 22 is a driver that receives code signals inputted from the keyboard 31 or the mouse 32c through the serial communication I/O 19a and accepts predetermined input operations.

The PRTDRV 21 is capable of performing predetermined processes on images for which an application program (not shown) provides a print instruction and predetermined color chart images, and printing them. In the computer 10, printer drivers respectively corresponding to the connected printers 40 are installed. Description will be representatively given to the PRTDRV 21 corresponding to the printer 40a with reference to the figure.

To perform printing operation, the PRTDRV 21 is provided with an image data acquisition module 21a, a color conversion module 21b, a halftone process module 21c, and a print data generation module 21d. When the above-mentioned print instruction is provided, the PRTDRV 21 is driven. The PRTDRV 21 sends data out to the display DRV 23, and causes it to display information indicating predetermined printing conditions and a UI (User Interface) screen (not shown) for inputting instructions for performing calibration.

When a user operates the keyboard 31, mouse 32, or the like to input information required for printing operation through the UI and provides an instruction to perform printing operation, the modules of the PRTDRV 21 are started. Various processes are carried out on predetermined image data, and print data is generated. The generated print data is outputted to the printer 40a through the USB I/O 19b, and the printer 40a performs printing operation according to the print data.

More specific description will be given. The image data acquisition module 21a acquires image data corresponding to a print image. This is accomplished by inputting predetermined input image data 17 from the HDD 15, or generating patch image data based on predetermined patch disposition information acquired by referring to a DB (DataBase) 16. At this time, a predetermined resolution conversion process is carried out on the acquired image data if necessary. The image data is dot matrix data in which the color of each pixel is defined by representing R, G, and B component colors in multiple tone, and it adopts a color system in accordance with the sRGB standard. Needless to add, various other data, such as JPEG image data adopting the YCbCr color system and image data adopting the CMYK color system, can be adopted.

The color conversion module 21b is a module that converts color systems by which the color of each pixel is indicated. It refers to color conversion LUTs 18 recorded on the HDD 15 as appropriate, and converts the SRGB color system of image data into the CMYK color system whose components correspond to the colored inks mounted in the printer 40a. The color conversion LUT 18 is a table in which colors are represented both by the sRGB color system and by the CMYK color system, and both the color systems are brought into correspondence. In this table, the correspondence is described with respect to a plurality of colors. Therefore, with respect to any color represented by the sRGB color system, a color in the CMYK color system can be computed by interpolation by referring to colors in the sRGB color system around the color, defined in a color conversion LUT 18. Thus, color conversion can be carried out.

When the color conversion module 21b carries out color conversion and CMYK data is obtained, the halftone process module 21c performs the following operation: it converts the gradation value of each pixel represented by the CMYK color system into halftone image data in which whether or not to discharge ink is specified with respect to each pixel. That is, it is determined whether or not to discharge an ink droplet with respect to each pixel in the printer 40a. Needless to add, the following constitution may be adopted: in addition to whether or not to discharge ink droplets, the quantity of discharged ink can be controlled stepwise, and the size of discharged ink droplets is determined.

The print data generation module 21d receives halftone image data, and rearranges it in the order of use in the printer 40a. Thus it generates print data by the amount of data used in one time of main scanning. The print data is outputted in succession to the printer 40a through the parallel communication I/O 19b. When all the data required for forming an image has been transferred to the printer 40a, the image is formed on media in the printer 40a.

The PRTDRV 21 is provided with a calibration module 21e. The calibration module 21e corrects color conversion LUTs 18 based on color values acquired from the color chart 60, as described later.

### (2) Printing Operation for Color Chart

The CMYK data acquired by the color conversion module 21b is image data in which each of the C, M, Y, and K colors is represented with a predetermined number of levels of gray (e.g., 256 levels of gray). Each gradation value corresponds to the quantity of ink in each color. The ink quantity denoted by a gradation value is determined in advance. For example, gradation values are so defined that 0 to 100% ink recording ratios per unit area linearly correspond to gradation values of 0 to 255. However, a problem arises in each printer 40. As printing operation is repeated, each mechanism for performing printing operation develops various changes over time in each of individual machines. For this reason, a problem results even if the ink quantity denoted by each gradation value is determined with respect to the C, M, Y, and K colors. Due to the above-mentioned changes over time, the coloring characteristics of each printer 40 deviate from the coloring characteristics of a printer that serves as the standard for the machines of the same model (reference machine). As a result, the ink quantity corresponding to each gradation value may not be able to be outputted.

To cope with this, the following operation is performed during calibration in this embodiment: color conversion LUTs 18 of a printer 40 to be calibrated is corrected based on color values acquired from the result of color measurement on a color chart 60 outputted from the printer 40. Specifically, the following is performed: the same image data is inputted to the printer 40 and a reference machine and is printed with these printers. At this time, the color conversion LUTs 18 are corrected so that the colors outputted from the printer 40 and the colors outputted form the reference machine are substantially identical with each other.

As mentioned above, color conversion LUTs 18 are to be corrected. Each printer 40 is provided with a plurality of such color conversion LUTS. This is because, when printing operation is performed with a printer 40 with various settings varied, the color conversion LUT 18 to be used also differs from setting to setting. Such settings include print resolution, the types of media used, print mode, and the like. Therefore, when a printer 40 is calibrated, calibration can be carried out with respect to each of a plurality of color conversion LUTs 18 provided for the printer 40. To correct such color conversion LUTs 18, printing of a color chart 60 must also be performed with respect to each of sets of printing conditions under which the color conversion LUTs 18 are used.

As illustrated in FIG. 1, this embodiment involves a plurality of printers 40 to be calibrated, and is so constructed that a plurality of color charts 60 can be outputted from each printer 40 with various settings varied. For this reason, during color measurement on each color chart 60, it is difficult for a user to accurately determine which color chart 60 was printed with which printer 40 and with what setting. Color charts 60 are more difficult to correctly discriminate especially in the following cases: cases where a plurality of color charts 60 are printed in a lump; and cases where color measurement is carried out when some time has passed after a color chart 60 is printed. To cope with this, the present invention is so constituted that printing conditions for a color chart 60 can be automatically identified just by measuring the colors of the color chart 60, as described later.

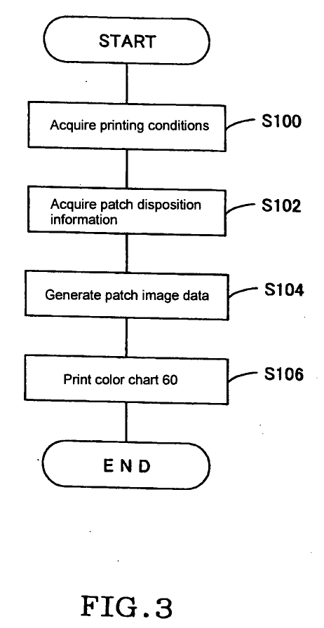

FIG. 3 is a flowchart illustrating the details of printing operation for a color chart 60.

When an instruction to perform printing operation for a color chart 60 is provided from a user through the UI, the PRTDRV 21 acquires printing conditions for printing the color chart 60 (Step S100). The processes of Steps S100 to S104 in the figure are basically carried out by the image data acquisition module 21a.

The printing conditions are set by the user through the UI. The PRTDRV acquires the model designation and serial number (hereafter, referred to as “individual unit identification information”) of a printer 40a with which the color chart 60 is printed. It also acquires various settings of print resolution, media used, print mode, and the like. That is, when the user desires to correct color shift produced when printing operation is performed under certain printing conditions, the user inputs the printing conditions to cause the color chart 60 to be printed. In this example, the individual unit identification information is inputted by the user. Instead, it may be automatically acquired from the firmware or the like of the printer 40a that performs printing operation.

The PRTDRV 21 accesses the DB 16, and acquires predetermined patch disposition information corresponding to the acquired printing conditions (Step S102).

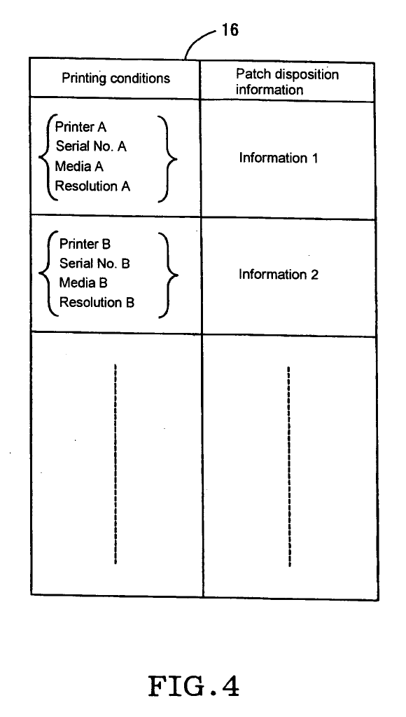

FIG. 4 illustrates an example of the entries of the DB 16. As illustrated in the figure, each set of printing conditions and patch disposition information uniquely corresponding thereto are recorded in pairs in the. DB 16.

In this figure, printing conditions {printer A (the model designation of the printer 40a), serial number A (the serial number of the printer 40a), media A, resolution A} correspond to patch disposition information 1; printing conditions {printer A, serial number B, media B, resolution A} correspond to patch disposition information 2. The patch disposition information is information that defines the disposed position of a predetermined patch of the patches constituting the color chart 60. The details of patch disposition information will be described later. In the example in FIG. 2, the DB 16 is placed on the HDD 15 of the computer 10, but needless to add, it may be placed in any other area. For example, it may be placed in a host computer or the like to which the computer 10 is connected as a client terminal.

After acquiring patch disposition information corresponding to printing conditions from the DB 16, as mentioned above, the PRTDRV 21 generates patch image data based on the acquired patch disposition information (Step S104). Here, description will be given to the relation between the patch disposition information and the color chart 60 with reference to a concrete example.

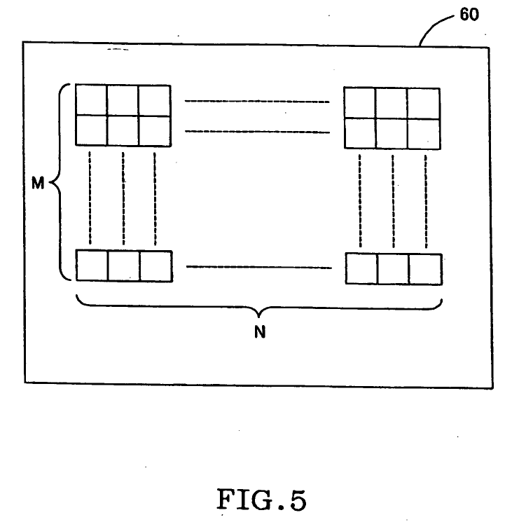

FIG. 5 illustrates a color chart 60 printed under certain patch disposition information. The color chart 60 is composed of M patches high by N patches wide. It is an assemblage of monochromatic patches printed with the ink recording ratio per unit area varied with a predetermined gradation value width with respect to each of the C, M, Y, and K colors. (The ink recording ratio per unit area will be hereafter simply referred to as “ink recording ratio.”) This embodiment is so constituted that the following is implemented: the disposed position of a predetermined patch is different from color chart 60 to color chart 60, but the number of patches in the height direction and in the width direction constituting each color chart 60 is standardized.

For the predetermined patch (specific information patch) whose disposed position is defined by patch disposition information, the following patches are used: blank patch with an ink recording ratio of 0 percent, where the brightness is maximized; and patch with the ink recording ratio of the K ink of 100 percent, where the brightness is minimized (K patch). In this embodiment, four colors, C, M, Y, and K, are used; therefore, four blank patches are provided on a color chart 60, and the number of the specific information patches is five in total. The patches used as the specific information patches are not limited to the foregoing. For example, the patches of the maximum concentration where the ink recording ratio of the C, M, and Y colors are 100 percent may be used as the specific information patches.

Information expressed by the same number of bits (N×M bits) as the number of patches of the color charts 60 can be used as the patch disposition information. More specific description will be given. These bits represented in binary form are arranged by the number equivalent to the number of patches of the color chart 60, like “000 . . . ” “1” is set for the bits of these bits, corresponding to the positions in which the specific information patches are disposed, and “0” is set for the other bits. As a result, each patch disposition information corresponding to each set of printing conditions becomes unique information in which “1” is set for specific bits (five bits in the above example) of N×M bits.

The correspondence between the bits and the positions of patches on the color chart 60 is defined as follows: the 1-by-1-th (width direction by height direction) patch in the color chart is brought into correspondence with the 1st bit; the 2-by-1-th and following patches adjoining in the width direction are brought into correspondence with the second and following bits; the 1-by-2-th patch is brought into correspondence with the N+1-th bit; and the 2-by-2-th and following patches adjoining in the width direction are correspondence with the N+2-th and following bits. Thus, the bits are brought into correspondence with the patch positions one by one, and the last N-by-M-th patch is brought into correspondence with the N-by-M-th bit.

Based on this patch disposition information, the above patch image data is generated. More specific description will be given. The patch image data is generated for outputting a color chart image in which the patches are disposed as follows: the specific information patch is disposed in the patch position corresponding to the bit at which “1” is set in the acquired patch disposition information. The other patches corresponding to predetermined gradation values with respect to each of C, M, Y, and K are disposed in the remaining patch positions at random.

Based on the above patch image data, the PRTDRV 21 prints a color chart 60 in which the predetermined patch disposition is specified in correspondence with certain printing conditions (Step S106). Needless to add, when such a color chart 60 is printed, the predetermined color conversion is carried out using color conversion LUTs 18 that are applied under the above printing conditions, and then print data is generated.

The patch disposition information stored in the DB 16 together with each set of printing conditions is not limited to the foregoing. Instead, the following constitution may be adopted:

For example, a predetermined function taking as variables the positions of the specific information patches disposed on the color chart 60 is used as the above patch disposition information. Letting patch disposition information be F, the numeric value expressed as follows is stored in the DB 16 in correspondence with each set of printing conditions:
F=n1+n2×N+n3×N²+n4×N³+p×N⁴ (1)
where, n1 to n4 are values indicating the positions of blank patches in the first layer (uppermost layer) to the fourth layer in each color chart 60 (Each of n1 to n4 takes a numeric value between 1 and N inclusive.);

p is a value indicating the order of the disposition of the K patch in all the patches of the color chart 60 (p takes a numeric value between 1 to N×M inclusive.) In this case, the order of disposition is determined as follows: the patch (1×1) in the left uppermost layer in the color chart 60 is taken as the first patch, and the patches in this layer are counted in the width direction. When the rightmost patch is counted, the patches are similarly counted in the next and following layers, and the N-by-M-th patch is taken as the last patch.

A plurality of pieces of patch disposition information F in the form of numeric value are determined, as mentioned above, and these numeric values are stored in the DB 16 in one-to-one correspondence with printing conditions. Needless to add, these pieces of patch disposition information F are individually separate values. After these numeric values are acquired at Step S102, computation is carried out at Step S104 to acquire the disposed positions of the specific information patches from the numeric values.

At the first step, the numeric value is divided by N⁴ to determine the quotient. This quotient corresponds to p mentioned above.

At the second step, the remainder obtained by subtracting p×N⁴ from the numeric value is divided by N³ to determine the quotient. This quotient corresponds to n4 mentioned above.

At the third step, the remainder obtained by subtracting n4×N³+p×N⁴ from the numeric value is divided by N² to determine the quotient. This quotient corresponds to n3 mentioned above.

At the fourth step, the remainder obtained by subtracting n3×N+n4×N³+p×N⁴ from the numeric value is divided by N to determine the quotient. This quotient corresponds to n2 mentioned above.

At the last step, the remainder obtained by subtracting n2×N+n3×N²+n4×N³+p×N⁴ from the numeric value is n1 mentioned above.

As mentioned above, n1 to n4 and p can be derived from the patch disposition information F. Therefore, the above patch image data is generated using these values. That is, patch image data is generated for outputting a color chart image in which patches are disposed as follows: a blank patch is disposed in the n1-th patch position from the left in the first layer in the color chart 60, the n2-th patch position from the left in the second layer, the n3-th patch position from the left in the third layer, and the n4-th patch position from the left in the fourth layer; a K patch is disposed in the p-th patch position of all the patch positions; and other patches corresponding to predetermined gradation values with respect to each of C, M, Y, and K are disposed in the remaining patch positions at random. Using this patch image data, the color chart 60 in which the disposition of predetermined patches is uniquely specified in correspondence with certain printing conditions is printed.

### (3) Calibration

Description will be given to a case in which calibration is carried out based on the result of color measurement on a color chart 60.

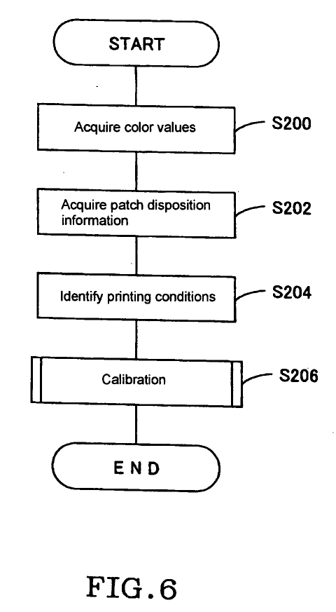

FIG. 6 is a flowchart illustrating the details of process steps from color measurement on the color chart 60 to calibration. As mentioned above, the PRTDRV 21 is provided with the calibration module 21e. When a user provides an instruction to carry out calibration from the UI, the PRTDRV 21 starts the calibration module 21e and performs the following process.

The calibration module 21e acquires the color value of each patch constituting the color chart 60 from the color measurement device 50 through the USB I/O 19b (Step S200). That is, the user measures the colors of the patches of the color chart 60 with the color measurement device 50 in predetermined order, and the color values are acquired as the result of the color measurement.

Then, the calibration module 21e determines the disposed positions of the four blank patches and the K patch in the color patch 60 according to the result of measurement on the color value L*a*b* of each patch. It generates patch disposition information based on the determined position of each specific information patch (Step S202).

In case information represented by the same number of bits as the number of patches of the color chart 60 is used as the patch disposition information, the following information is generated when the color chart 60 is printed: bit information in which “1” is set for bits corresponding to the positions of the specific information patches, of the N×M bits that are identical in number with patches. The calibration module 21e accesses the DB 16 and identifies predetermined printing conditions corresponding to the obtained patch disposition information (Step S204).

The patch disposition information obtained at Step S202 agrees with the patch disposition information used for generating the patch image data associated with the color chart 60 subjected to color measurement. As mentioned above, the DB 16 holds printing conditions and patch disposition information uniquely corresponding thereto in pairs. At Step S204, therefore, the printing conditions under which the color chart 60 subjected to color measurement at that time was printed are precisely identified.

Also, in case the patch disposition information F represented by Expression (1) above is used when the color chart 60 is printed, printing conditions can be similarly identified. At Step S202, in this case, patch disposition information is acquired by the following procedure: first, the positions n1 to n4 of blank patches in the individual layers of the color chart 60 are acquired from the result of color measurement on these layers. At the same time, the order of the position of the K patch in all the patches, or p, is acquired. The acquired n1 to n4 and p are substituted into Expression (1) above, and the computed numeric value is used as patch disposition information.

At Step S204, referring to the DB 16, a set of printing conditions uniquely corresponding to the acquired patch disposition information is determined. Also, in this case, the acquired patch disposition information agrees with the patch disposition information used to print the color chart 60 subjected to color measurement. Therefore, the calibration module 21e can precisely identify printing conditions under which the color chart 60 subjected to color measurement at that time was printed.

According to the present invention, as mentioned above, only patches corresponding to predetermined gradation values with respect to each of ink colors are printed, and only patches are subjected to color measurement. Unlike conventional practices, therefore, wasteful printing operation or color measurement need not be performed, and each color chart 60 can be efficiently discriminated. In addition, any marking other than patches need not be scanned. Therefore, a color measurement device that is only provided with a color measurement function without a function of optically recognizing barcodes or characters or the like can be used. As a result, the range of equipment required for embodying the invention is not unnecessarily narrowed.

After the printing conditions for the color chart 60 subjected to color measurement are identified, the calibration module 21e carries out calibration using the color values of the color chart 60 (Step S206). In this embodiment, as mentioned above, the computer 10 is connected with a plurality of the printers 40. The HDD 15 holds color conversion LUTs 18 used when printing operation is performed with the settings of print resolution, media used, and the like varied from printer 40 to printer 40.

Therefore, when a color chart 60 outputted under certain printing conditions is subjected to color measurement in an attempt to eliminate color shift found in a print result under the printing conditions, the following procedure must be taken: color values from the color measurement must be used for correcting color conversion LUTs 18 to be used under the same printing conditions. Consequently, the calibration module 21e selects a color conversion LUT 18 to be used under the identified printing conditions from among a plurality of the color conversion LUTs 18 stored on the HDD 15. Then, it corrects the selected color conversion LUT 18.

If printing conditions {printer A, serial number A, media A, resolution A} are identified, for example, the calibration module 21e performs the following operation: it selects a color conversion LUT 18 to be used under the settings of media A and resolution A from among a plurality of the color conversion LUTs 18 stored for the printer 40a, and carries out the following calibration.

Concrete description will be given to a technique for calibration.

In calibration, a predetermined color correction table 18a is generated using the color values acquired from the color patch 60 and the predetermined reference values 19 generated and recorded on the HDD 15 in advance. The reference value 19 refers to correspondence between the gradation values of C, M, Y, and K and color values acquired by measuring the colors of color patches. These color patches are printed with all the gradation values (256 levels of gray) with respect to each of the C, M, Y, and K colors with a reference machine of the same model as the printer to be calibrated. It is assumed that such reference values 19 are determined with respect to each set of printing conditions to be subjected to color correction. The reason for this is as follows: even with the same printer, the color values of print result from the same CMYK data differ if various settings of media used and the like differ. For this reason, to make colors printed with the same printer uniform regardless of difference in various settings, the correspondence between CMYK data and color values that serves as the reference must be varied according to various settings.

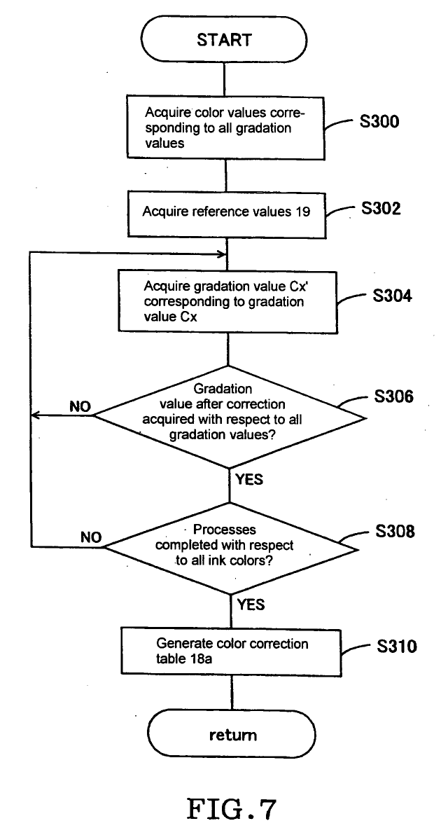

FIG. 7 is a flowchart illustrating the calibration process in details.

At Step S300, the calibration module 21e carries out predetermined interpolation, referring to the acquired color values, and thereby acquires the color values corresponding to all the gradation values. More specific description will be given. The color values acquired from the individual patches are color values corresponding to non-consecutive gradation values with respect to each of C, M, Y, and K. Therefore, color values corresponding to other gradation values are also determined by interpolation. For this purpose, various interpolation techniques, such as linear interpolation and spline interpolation, can be used. Then, the calibration module 21e acquires reference values 19 corresponding to printing conditions to be corrected (Step S302). It acquires gradation value Cx′ as the correction value for gradation value Cx (Step S304).

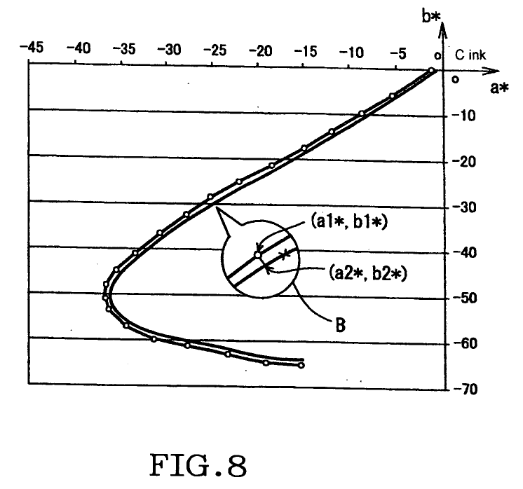

FIG. 8 plots the color values obtained as the result of interpolation and the reference values 19 on the same a*b* plane.

If there is no color shift produced in a print result from the reference machine and in a print result from the printer 40a, the following should take place: when print results (in this case, single cyan color) obtained by performing printing operation with the same gradation value Cx are subjected to color measurement, the same color values should be obtained. If color shift is produced between a print result from the reference machine and a print result from the printer 40a, the following occurs: as illustrated in the figure, the graph plotting the color values obtained as the result of interpolation is displaced on the a*b* plane from the line connecting reference values (hollow circles). In this figure, all the reference values are not indicated by hollow circles but only some of reference values are indicated by hollow circles.

Enlarged illustration B in the figure indicates the color values of print results, obtained when printing operation is performed with the same gradation value Cx with the reference machine and the printer 40a, by hollow circle and crisscross. The following is a description of the process of Step S304 with reference to enlarged illustration B: a color value (a2*, b2*) whose color difference ΔE from the reference value (a1*, b1*) corresponding to gradation value Cx is smallest is found from among color values corresponding to all the gradation values on the graph. Then, gradation value Cx′ corresponding to the color value is acquired.

This process is equivalent to computing the gradation value Cx′ for outputting output colors as the approximate value of output colors outputted from the reference machine with gradation value Cx from the printer 40a. The correspondence in which the gradation value Cx′ is gradation value after correction and the gradation value Cx is gradation value before correction is defined. This makes it possible to generate a color correction table 18a that allows color shift that used to be produced under the identified printing conditions to be corrected with accuracy.

As Step S306, it is determined whether the gradation value corresponding to the color value on the graph whose color difference ΔE is smallest has been acquired or not with respect to the reference values associated with all the gradation values. If it is determined that the process has not been completed with respect to all the gradation values, the process of Step S304 is repeated until the corresponding gradation value has been acquired with respect to the reference values associated with all the gradation values. If it is determined that the process of Step S304 has been completed with respect to the reference values associated with all the gradation values, the following is determined at Step S308: whether the processes of S304 and the following step have been completed or not with respect to all the ink colors used in the printer 40a.

If it is determined that the processes of Step s304 and the following step have not been completed with respect to all the ink colors, the ink color to be processed is changed, and the processes of Step S304 and the following step are repeated. If it is determined that the processes of Step S304 and the following step have been completed with respect to all the ink colors, the calibration module 21e generates a color correction table 18a (Step S310). The color correction table defines the correspondence between the gradation value before correction and the computed gradation value after correction with all the gradation values with respect to each ink color.

When printing operation is thereafter performed under the identified printing conditions, the result of conversion by a color conversion LUT 18 to be corrected is corrected using the generated color correction table 18a. That is, gradation values after conversion by the color conversion LUT 18 are taken as input values (CMYK), and converted values obtained by referring to the color correction table 18a are taken as (C′M′Y′K′). Then, the converted values (C′M′Y′K′) are inputted to the halftone process module 21c. Thus, output colors equivalent to those of the reference machine that are the identified printing conditions can be obtained.

In the example described above, the result of conversion by a color conversion LUT 18 is further converted by a color correction table 18a. Instead, the following constitution may be adopted: one LUT in which input values (RGB data) for the color conversion LUT 18 and output values of the color correction table 18a are brought into correspondence with each other is generated. The color conversion LUT 18 is updated with the generated LUT.

### (4) Other Embodiments

According to the present invention, as described above, the printing conditions for a color chart 60a can be automatically identified just by measuring the color of each patch of the color chart 60. If a user is notified of this result of identification, the user can carry out calibration more conveniently.

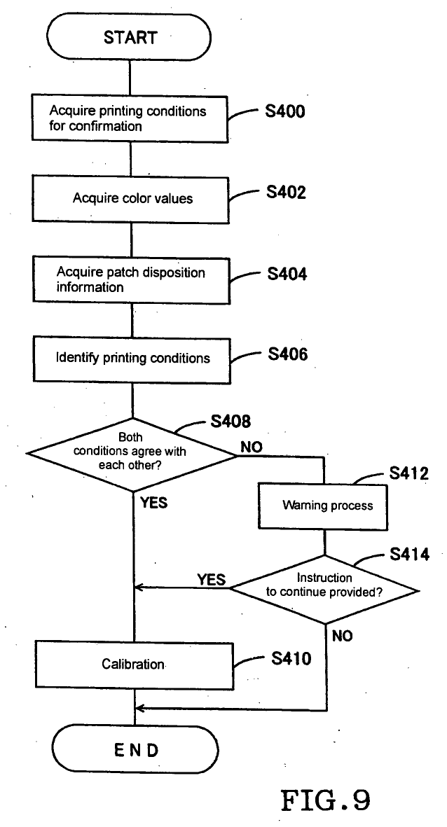

FIG. 9 is a flowchart illustrating the details of process steps from color measurement on a color chart 60 to calibration, and illustrates an example different from that illustrated in FIG. 6. Description will be given mainly to differences from the example illustrated in FIG. 6.

In the example illustrated in FIG. 9, the calibration module 21e acquires confirming printing conditions (printing conditions for confirmation) inputted as printing conditions for the color chart 60 to be subjected to color measurement (Step S400). The printing conditions for confirmation are conditions that the user recognizes as the printing conditions for the color chart 60 to be subjected to color measurement. They are information inputted from the UI or the like when the color chart 60 is subjected to color measurement. After acquisition of the color value of each patch, acquisition of patch disposition information, and identification of printing conditions (Steps S402 to S406), the calibration module 21e performs the following operation: it determines whether the printing conditions for confirmation agree with the identified printing conditions or not (Step S408).

The printing conditions for confirmation need not always be acquired before the acquisition of color values, and they only have to be acquired ahead of the process of Step S408. Of printing conditions for confirmation, printer model designation and serial number may be acquired from the firmware or the like of the printer 40a to be calibrated, instead of being inputted by the user. If it is determined at Step S408 that both the conditions agree with each other, the color chart 60 required for carrying out the user's intended calibration has been subjected to color measurement. Consequently, as described above with respect to Step S206, calibration is carried out using color values obtained from color measurement (Step S410).

Both the conditions may not agree with each other. The reason for this is as follows: a user may print a plurality of color charts 60 under each set of printing conditions, or some time may have passed before color measurement after a color chart 60 is printed. In these cases, the printing conditions for each color chart 60 are not always recognized with accuracy when the color chart is subjected to color measurement.

If it determined that there is a difference between both the conditions, the calibration module 21e carries out a predetermined warning process at Step S412. This warning process is carried out, for example, by providing an indication of disagreement between both the conditions on the display 33 through the display DRV 23, or displaying items of difference. Given the warning, the user learns that the user subjected a color chart 60 different from that recognized by the user him/herself to color measurement. Therefore, the user can decide to or not to continue the calibration.

Consequently, the calibration module 21e determines whether an instruction to continue the calibration has been provided or not from the UI or the like (Step S414). If there is an instruction to continue, the calibration module carries out the calibration. In this case, the user chose to correct a color conversion LUT 18 used under the printing conditions for the color chart 60 subjected to color measurement, though the color conversion LUT 18 is different from that the user intended to correct. If there is no instruction to continue, the calibration module does not correct the color conversion LUT 18 using the acquired color values, but terminates the processing. In this case, the user can subject a different color chart 60 to color measurement to carry out the intended calibration.

The present invention has a beneficial effect in the following situation:

There are cases where a user desires to calibrate a printer 40 owned by the user but the user him/herself does not have a color measurement device 50. To cope with this, such a service as described below is possible. The color chart 60 printed by each user is submitted, and data associated with color values obtained by subjecting the color chart 60 to color measurement is sent to the user. In this case, users print a color chart 60 of the present invention in which the disposed positions of predetermined patches are uniquely determined according to each set of printing conditions. Thus, a person who provides the above service can precisely identify the printing conditions for the color chart 60 submitted from each user by referring to the above DB 16. Then, the user is notified of the printing conditions together with color values obtained through color measurement. Thus, the user is prevented from misidentifying printing conditions to be calibrated using the acquired color values.

### (5) Conclusion

According to the present invention, as mentioned above, the printing conditions for each color chart 60 can be precisely identified without performing wasteful printing operation or color measurement by taking the following procedure: patch disposition information uniquely corresponding to individual sets of printing conditions is acquired from the DB 16; a color chart 60 in which the disposition of predetermined patches is specified based on the patch disposition information is printed; the color of each patch of the color chart 60 is measured; printing conditions corresponding to patch disposition information obtained from the result of color measurement are acquired from the DB 16. Also, in case calibration is carried out with a plurality of printers 40 with various settings varied, mismatch of a color conversion LUT 18 to be corrected and color values to be used can be prevented. If a user erroneously recognizes the printing conditions for a color chart 60 subjected color measurement, a warning can be given to inform the user of this mistake.

1. A color chart discrimination program product, including:
a printing condition acquisition program code that acquires predetermined printing conditions under which a color chart is outputted from a printing device;
a color chart output program code that outputs a color chart in which the disposition of predetermined patches is specified in correspondence with the acquired printing conditions under the printing conditions; and
a printing condition identification program code that, when the color chart is subjected to color measurement to acquire the color value of each patch, acquires the disposed positions of the predetermined patches, and identifies the printing conditions based on the disposed positions,
wherein a computer is caused to execute these program codes.

2. The color chart discrimination program product according to claim 1,
wherein the printing conditions acquired by the printing condition acquisition program code include at least information for identifying printing devices that output color charts.

3. The color chart discrimination program product according to claim 2,
wherein the color chart output program code refers to the correspondence between printing conditions and patch disposition information that defines the disposed positions of the predetermined patches in color charts, stored in a predetermined storage area in advance, thereby acquires patch disposition information corresponding to each set of printing conditions, and outputs the color chart in which the disposed positions of the predetermined patches are specified based on the acquired patch disposition information.

4. The color chart discrimination program product according to claim 3,
wherein the printing condition identification program code acquires specific patch disposition information based on the result of color measurement on the color chart, and further identifies the printing conditions by referring to the correspondence.

5. A color correction program product for correcting color shift in a printing device using the color chart discrimination program product according to claim 1,
wherein when the printing conditions are identified based on the color measurement, a computer is caused to execute a color correction program code that corrects correspondence for color conversion applied during printing operation under the identified printing conditions based on the acquired color value of each patch.

6. The color correction program code according to claim 5,
wherein printing conditions identified based on the color measurement and printing conditions for confirmation separately acquired as printing conditions under which the color chart was outputted are compared with each other, and, if there is any difference between both the conditions, a computer is caused to carry out a predetermined warning process.

7. A color chart discrimination device, comprising:
a printing condition acquisition unit that acquires predetermined printing conditions under which a color chart is outputted from a printing device;
a color chart output unit that outputs a color chart in which the disposition of predetermined patches is specified in correspondence with the acquired printing conditions under the printing conditions; and
a printing condition identification unit that, when the color chart is subjected to color measurement to acquire the color value of each patch, acquires the disposed positions of the predetermined patches, and identifies the printing conditions based on the disposed positions.

8. A color chart discrimination method,
wherein predetermined printing conditions under which a color chart is outputted from a printing device are acquired,
wherein a color chart in which the disposition of the predetermined patches is specified in correspondence with the acquired printing conditions is outputted under the printing conditions, and
wherein when the color chart is subjected to color measurement to acquire the color value of each patch, the disposed positions of the predetermined patches are acquired, and the printing conditions are identified based on the disposed positions.

9. A color correction device for correcting color shift in a printing device using a color chart discrimination device according to claim 7,
wherein a color correction unit is provided which, when the printing conditions are identified based on the color measurement, corrects correspondence for color conversion applied during printing operation under the identified printing conditions based on the acquired color value of each patch.

10. A color correction method for correcting color shift in a printing device using a color chart discrimination method according to claim 8,
wherein when the printing conditions are identified based on the color measurement, correspondence for color conversion applied during printing operation under the identified printing conditions is corrected based on the acquired color value of each patch.
